(19) United States
(12) Patent Application Publication
(10) Pub. No.: US 2016/0096494 A1
(43) Pub. Date: Apr. 7, 2016

(54) AUTOMOTIVE AUDIO COMMAND SYSTEM

(71) Applicant: Michelle Mayo, Live Oak, FL (US)

(72) Inventor: Michelle Mayo, Live Oak, FL (US)

(21) Appl. No.: 14/508,242

(22) Filed: Oct. 7, 2014

(51) Int. Cl. B60R 16/037

(52) U.S. Cl. CPC B60R 16/0373

(57) ABSTRACT

A control system for an vehicle comprising: a series of control tabs arranged on a steering wheel of the vehicle; a control panel within the vehicle, where the control panel includes a series of control indicators; software within the control system, the software enables a voice recognition and voice command protocol; a voice command microphone positioned on the steering wheel; and memory provided in the control system, where the memory stores parameters provided through the voice command protocol and said parameters are set for each of a plurality of drivers. The parameters may preferably include settings for a rear view mirror in the vehicle and any side mirrors provided on the vehicle and each driver sets driver specific parameters for the rear view mirror and any side mirrors. Finally, each driver may set parameters associated with the control of the radio, music, navigation and phone operation.

### BACKGROUND OF THE INVENTION

1. Field of Invention

The present invention relates to an audio command system integrated within the automobile.

2. Description of Related Art

The present invention relates to an audio command system that is used to control various systems within an automobile. Many automobiles have integrated various systems to include features to assist in the operation and enjoyment of driving an automobile. Many automobiles are equipped with cruise control systems, cell phone integration, audio systems and various other electronics that control the overall operation of the automobile. The driver usually has a control panel within the automobile that allows the driver to set the parameters associated with the various systems. These control systems may be set and operated by various drivers. One drawback is that a new or alternative driver may have to reset certain parameters upon operation of the automobile. One particular parameter relates to the adjustment of the rear view and side mirrors. Although most automobiles have electronic controls for the setting of these mirrors a particular driver may have to reset these settings if another second driver is also using the automobile. Further other systems such as cell phone integration, music, radio or other audio systems may require resetting to the particular driver's needs and desires. As a consequence, it would be advantageous to have an audio command feature integrated within the control systems of an automobile. Through the audio command system, a driver may verbally set the systems to the appropriate settings that have been saved for that particular driver.

### SUMMARY OF THE INVENTION

The present invention relates to a control system for an vehicle comprising: a series of control tabs arranged on a steering wheel of the vehicle; a control panel within the vehicle, where the control panel includes a series of control indicators; software within the control system, the software enables a voice recognition and voice command protocol; a voice command microphone positioned on the steering wheel; and memory provided in the control system, where the memory stores parameters provided through the voice command protocol and said parameters are set for each of a plurality of drivers. In one exemplary embodiment, the series of control tabs may be positioned on the perimeter of a center piece of the steering wheel. Further, the series of control indicators may include radio, music, navigation, phone and driver indication. The parameters may preferably include settings for a rear view mirror in the vehicle and any side mirrors provided on the vehicle and each driver sets driver specific parameters for the rear view mirror and any side mirrors. Finally, each driver may set parameters associated with the control of the radio, music, navigation and phone operation.

### BRIEF DESCRIPTION OF DRAWINGS

FIG. 1 depicts a steering wheel control system used in accordance with the present invention.

FIG. 2 depicts a control panel used in conjunction with the present invention.

### DETAILED DESCRIPTION

The present invention relates to an automotive audio control system that is used to control various driver systems within an automobile. The present invention uses audio commands that are received through a microphone and interpreted by a control system to control various aspects of an automobile. In particular, the audio commands receive an audio indication of a driver designation. Once this driver designation is received the control system sets the automotive controls to a preset parameter that has been designated by the particular driver. These audio commands are integrated within the audio control system of the car and therefore the parameters are adjusted in accordance with the designated driver. Driver designations are stored in memory within a memory card provided in the system and therefore multiple drivers may designate appropriate parameters and commands associated with each driver. These commands may be related to the operation and adjustment of rear view and side mirrors or other parameters such as music selection, cell phone operation and driver seat positioning.

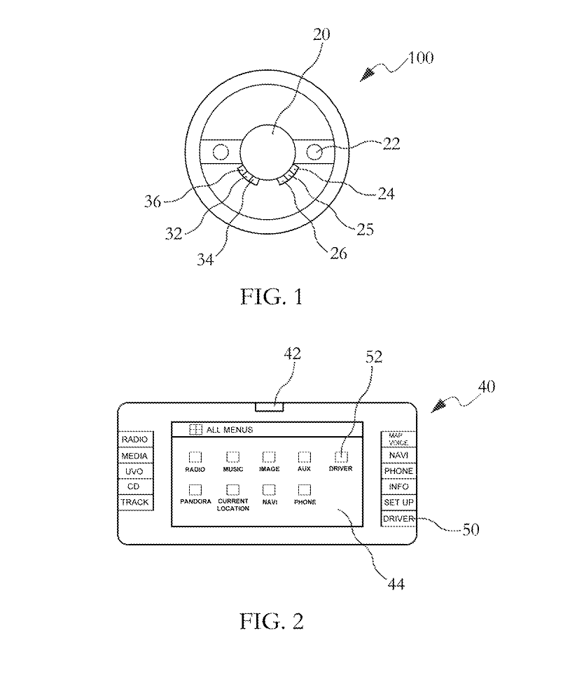

In reference to FIG. 1, a steering wheel 100 in accordance with the present invention is depicted. The steering wheel 100 includes a series of control tabs that surround a center piece 20 of the steering wheel 100. The control tabs include an audio command microphone 36, phone call indicator 32, end call tab 34, trip set 24, reset tab 25, and mode tab 26. Cruise control may be activated by a button 22 on one side of the center piece 20. These convenient hand operated control tabs along with the microphone 36 provide the user with an effective control system at the user's finger tips. The voice commands are controlled through a central control panel 40 as shown in FIG. 2. The central control panel 40 includes a display screen 44 and a memory card 42. As shown on the display screen 44, a driver designator 52 is provided. A driver indicator 50 is shown along one side of other indicators related to the control system 40. In order to set driver designated parameters, a driver depresses the driver designator 52 designating himself or herself as a driver such as a Driver 1, Driver 2 or other parameters such as Drivers A, B, or C. During the designation process the driver may set various parameters associated with their particular operation of the vehicle. The preset parameters may include settings for the rear and side view mirrors along with other electronic parameters as desired by the driver. After completion the driver indicator 50 provides an indication of the parameters in operation when the car is initiated for driving. Through the voice command microphone a driver may designate a designated preset driver parameter associated with the particular driver. For example Driver A may indicate Driver A in operation, set Driver A parameters. Further, if Driver B should take over control of the vehicle, Driver B may provide an audio command received by the control system 40 to activate parameters set by the Driver B. This system provides an efficient and effective manner to have all parameters set for a particular driver stored in memory provided by the control system 40. The control system 40 further includes a memory card 42 that stores all driver parameters associated with each driver designated within the system. The instant invention has been shown and described in what it considers to be the most practical and preferred embodiments. It is recognized, however, that departures may be made there from within the scope of the invention and that obvious modifications will occur to a person skilled in the art.

What is claimed is:

1. A control system for an vehicle comprising:
a. a series of control tabs arranged on a steering wheel of the vehicle;
b. a control panel within the vehicle, where the control panel includes a series of control indicators;
c. software within the control system, the software enables a voice recognition and voice command protocol;
d. a voice command microphone positioned on the steering wheel; and
e. memory provided in the control system, where the memory stores parameters provided through the voice command protocol and said parameters are set for each of a plurality of drivers.

2. The control system according to claim 1, wherein the series of control tabs is positioned on the perimeter of a center piece of the steering wheel.

3. The control system according to claim 1, wherein the series of control indicators includes radio, music, navigation, phone and driver indication.

4. The control system according to claim 1, wherein the parameters include settings for a rear view mirror in the vehicle and any side mirrors provided on the vehicle.

5. The control system according to claim 4, where each driver sets parameters for the rear view mirror and any side mirrors.

6. The control system according to claim 3, where each driver sets parameters associated with the control of the radio, music, navigation and phone operation.

7. The control system according to claim 5, where any active driver activates the set parameters through the voice command protocol.

8. The control system according to claim 6, where any active driver activates the set parameters through the voice command protocol.
